(19) United States
(12) Patent Application Publication
(10) Pub. No.: US 2010/0246168 A1
(43) Pub. Date: Sep. 30, 2010

(54) REFLECTOR WITH COATING FOR A FLUORESCENT LIGHT FIXTURE

(75) Inventors: Neal R. Verfuerth, Plymouth, WI (US); Troy M. Johnson, St. Cloud, WI (US); Kenneth J. Wetenkamp, Plymouth, WI (US); John Hassert, Chetek, WI (US)

Correspondence Address: FOLEY & LARDNER LLP, 777 EAST WISCONSIN AVENUE, MILWAUKEE, WI, 53202-5306, US

(73) Assignee: Orion Energy Systems, Inc.

(21) Appl. No.: 12/748,323

(22) Filed: Mar. 26, 2010

Related U.S. Application Data
(60) Provisional application No. 61/165,397, filed on Mar. 31, 2009.

(51) Int. Cl. F21V 7/00; H01J 9/00

(52) U.S. Cl. 362/217.05; 445/27

(57) ABSTRACT

A fluorescent light fixture includes a frame supporting a reflector having at least one elongated recess, the recess having a light reflecting side configured to at least partially surround at least one elongated fluorescent bulb having a diameter D, and defined by a geometry having a convex portion merging with angled sidewalls. A powder coating is disposed on the light reflecting side of the recess of the reflector. A method of making a fluorescent light fixture includes providing a frame supporting the reflector, the reflector having a recess with a light reflecting side to at least partially surround a fluorescent bulb, the recess defined by a geometry having a convex portion merging with angled sidewalls, and applying a white thermosetting powder coating on the light reflecting side of the recess of the reflector.

### CROSS REFERENCE TO RELATED APPLICATIONS

The present Application claims the benefit of priority under 35 U.S.C. §119(e)(1) of U.S. Provisional Patent Application No. 61/165,397, titled “Reflector With Coating For A Fluorescent Light Fixture” and filed on Mar. 31, 2009, the disclosure of which is incorporated herein by reference in its entirety.

### FIELD

The present invention relates to a reflector for a fluorescent light fixture. The present invention relates more particularly to a fluorescent light fixture reflector having a coating. The present invention relates more particularly to a fluorescent light fixture reflector having a white reflective powder coating applied thereon.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

It would be desirable to provide an improved reflector for a fluorescent lighting fixture that can be manufactured relatively quickly and inexpensively, and that can provide increased light output from a fixture in a more diffuse manner and using generally the same power input as conventional fixtures, or that can provide approximately the same light output to diffuse locations as conventional fixtures but with reduced power input. However, the problems posed by such reflectors are complex because several factors tend to influence the light output capability of a fixture including the specific geometry of the reflector body, the reflectivity of the surface of the reflectors, ability to withstand high temperatures, and the costs and other drawbacks associated with conventional finishes used on the reflector surface (e.g. polished aluminum, mirror finishes, reflective appliqués such as Mylar, foil, liquid coatings such as paints, epoxies, etc.) that tend to raise the costs and adversely effect the light emitting performance of the fixture. For example, typical reflectors for fluorescent lighting fixtures tend to concentrate light output in a downward direction (i.e. toward the floor) and do not provide a sufficiently desirable diffuse lighting characteristic (e.g. towards sidewalls, etc.).

Accordingly, it would be desirable to provide a reflector for a fluorescent light fixture that is relatively easy to manufacture at reduced cost and that provides enhanced light emitting capability and diffuse lighting characteristics for a fixture.

### SUMMARY

According to one embodiment, a fluorescent light fixture includes a frame supporting a reflector having at least one elongated recess, the recess having a light reflecting side configured to at least partially surround at least one elongated fluorescent bulb, and defined by a geometry having a convex portion merging with angled sidewalls, and a powder coating disposed on the light reflecting side of the recess of the reflector.

According to another embodiment, a fluorescent light fixture includes a frame supporting a reflector having at least one elongated recess, the recess having a light reflecting side configured to at least partially surround at least one elongated fluorescent bulb, and defined by a geometry having a convex portion merging with angled sidewalls, and a white thermosetting powder coating disposed on the light reflecting side of the recess of the reflector, and having a thickness within the range of approximately 2-4 mils.

According to a further embodiment, a method of making a fluorescent light fixture includes providing a frame supporting a reflector having at least one elongated recess, the recess having a light reflecting side configured to at least partially surround at least one elongated fluorescent bulb, and defined by a geometry having a convex portion merging with angled sidewalls, and applying a white thermosetting powder coating on the light reflecting side of the recess of the reflector to a thickness within the range of approximately 2-4 mils.

### BRIEF DESCRIPTION OF THE DRAWINGS

FIG. 1 is a schematic image of a cross sectional view of a fluorescent light fixture having reflectors with a reflective coating according to an exemplary embodiment.

FIG. 2 is a schematic image of a cross sectional view of a reflector with a reflective coating for a fluorescent light fixture according to an exemplary embodiment.

FIG. 3 is a schematic image of a cross sectional view of a reflector with a reflective coating for a fluorescent light fixture according to another exemplary embodiment.

FIG. 4 is a schematic image of a cross sectional view of a reflector with a reflective coating for a fluorescent light fixture according to another exemplary embodiment.

FIG. 5 is a schematic image of a cross sectional view of a reflector with a reflective coating for a fluorescent light fixture according to another exemplary embodiment.

FIG. 6 is a schematic image of a cross sectional view of a reflector with a reflective coating for a fluorescent light fixture according to another exemplary embodiment.

FIG. 7 is a schematic flow chart of a process for coating a reflector for a fluorescent light fixture according to another exemplary embodiment.

FIG. 8 is a schematic flow chart of a coating process for a reflector for a fluorescent light fixture according to another exemplary embodiment.

FIG. 9 is a schematic flow diagram of a coating process for a reflector for a fluorescent light fixture according to another exemplary embodiment.

FIGS. 10-14 are schematic images of a cross sectional view of a reflector with a reflective coating for a fluorescent light fixture according to another exemplary embodiment.

### DETAILED DESCRIPTION

Referring to the FIGURES, a reflector for a fluorescent light fixture is shown according to an exemplary embodiment that is less expensive and more easily manufactured than conventional fluorescent light fixture reflectors. The fixture includes a reflector having a body portion with a defined geometry and a white reflective thermosetting powder coating applied to a light reflecting side of the body (i.e. a side of the reflector body that faces toward a fluorescent light bulb). The white reflective coating has reflective properties, which in combination with the defined geometry of the reflector, provides a superior reflector for use with a fluorescent light fixture. The reflector as shown and described herein may be of a single width type configured for use with a single fluorescent light bulb, or may be a multiple width type configured for use in a fixture having multiple fluorescent light bulbs. Although the reflectors and fixtures are shown and described herein by way of example for use with elongated linear fluorescent light bulbs, the reflectors and coatings of the present invention may be adapted for use with other bulb configurations. All such variations are intended to be within the scope of this disclosure.

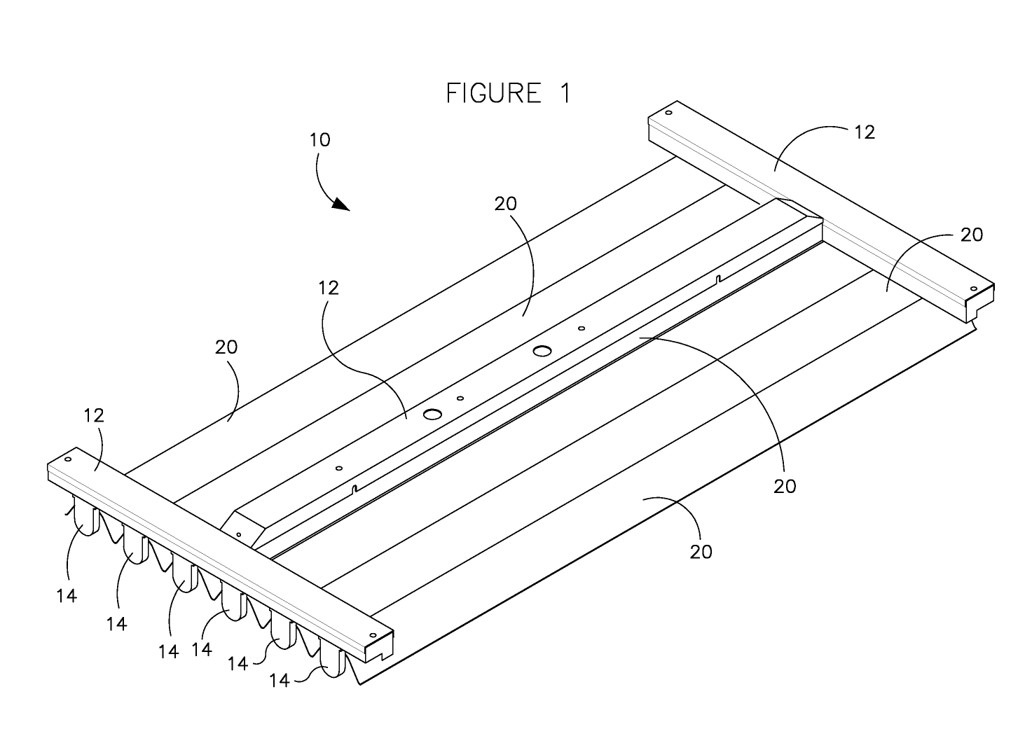

Referring to FIG. 1, a fluorescent light fixture 10 having reflectors with a reflective thermosetting powder coating is shown according to an exemplary embodiment. Fluorescent light fixture 10 is shown by way of example to include a frame 12, elongated reflectors 20 having a shaped geometry, and lamp holders 14 for holding elongated fluorescent bulbs in a parallel relationship adjacent to the curved geometries of the reflectors. The fixture also includes other components such as raceways within the frame for routing wiring from an input connector to a ballast and to the lamp holders (not shown), and other suitable electrical components. The side of the reflectors 20 that face the fluorescent bulbs is coated with a reflective coating, and the reflectors have a geometry that is shaped to at least partially surround the fluorescent bulb, so that the combination of the reflector's geometric shape and reflective coating optimize a quantity of light emitted from the fixture for a given quantity of energy drawn by the fixture. According to other embodiments, the fluorescent light fixture may be any suitable fixture having reflectors configured to emit light from one or more fluorescent bulbs.

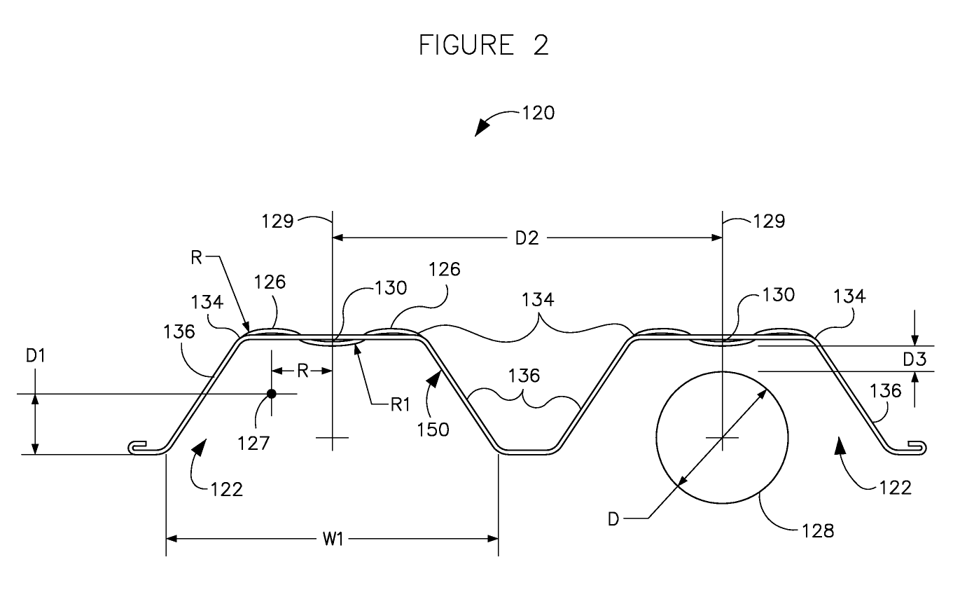

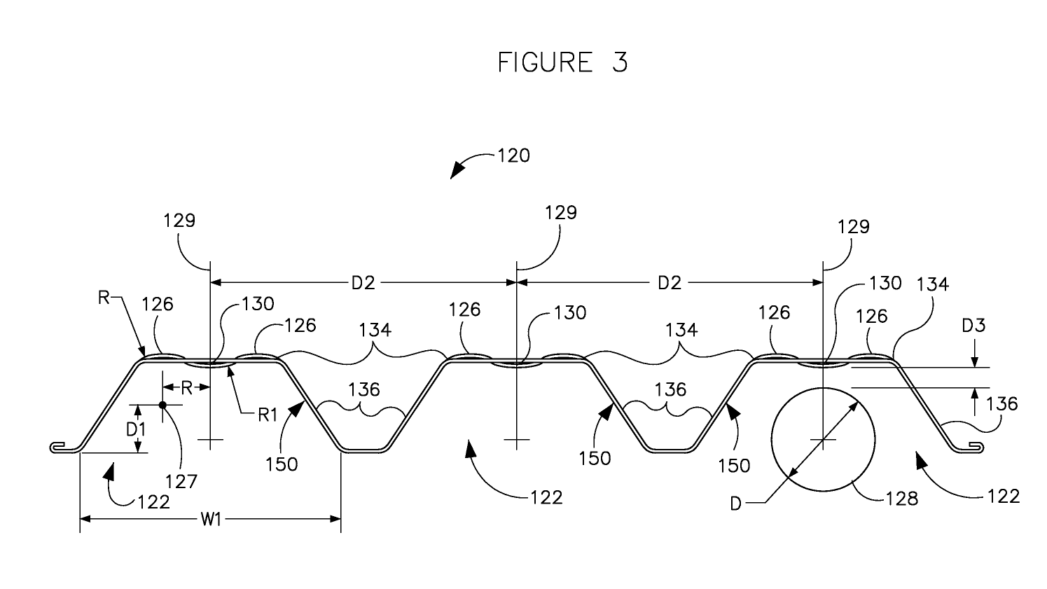

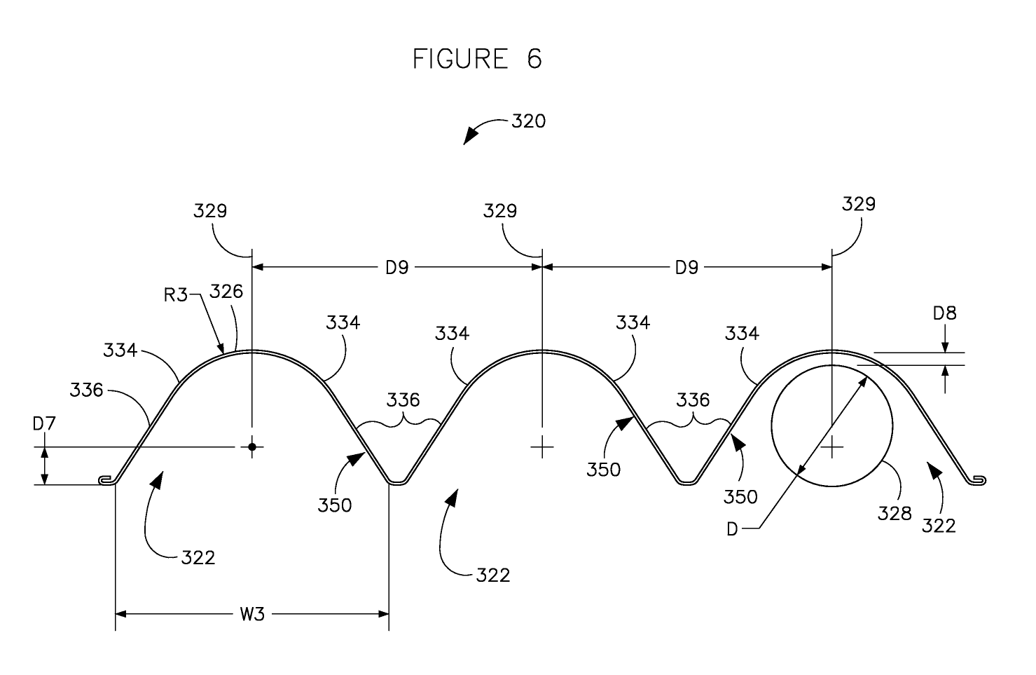

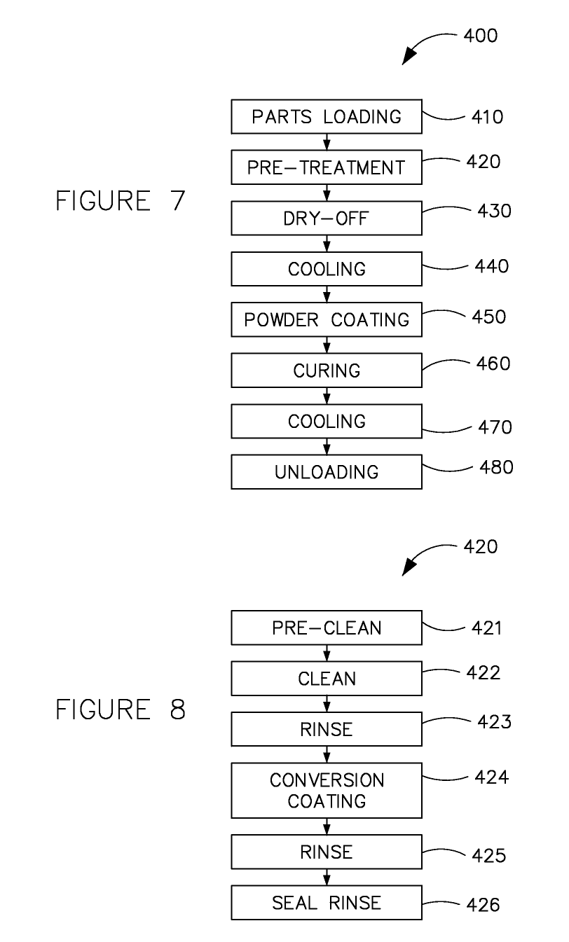

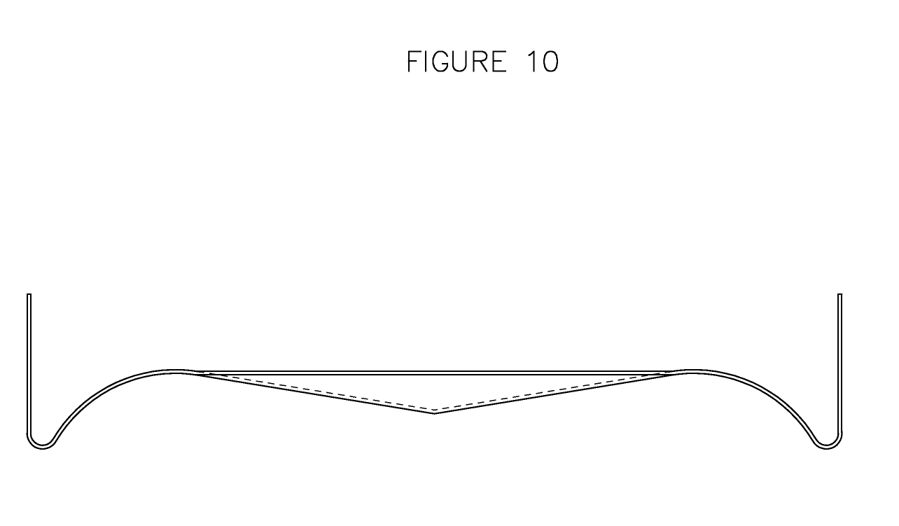

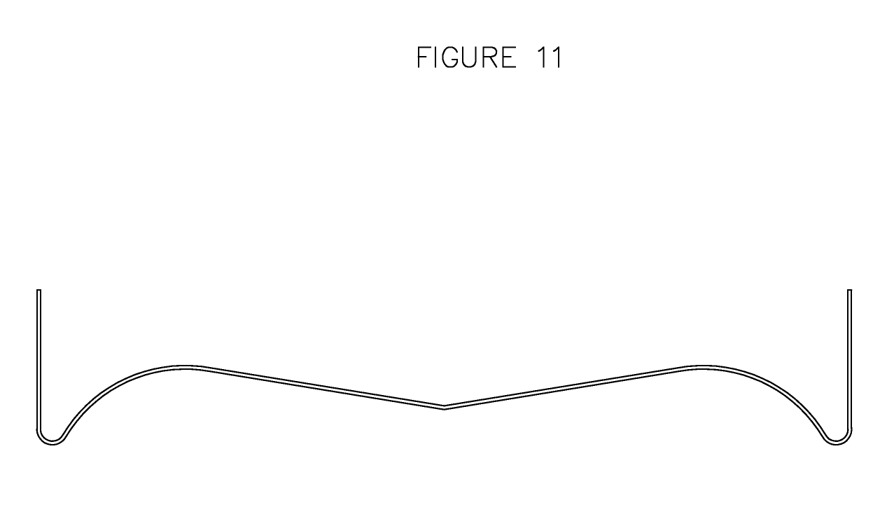

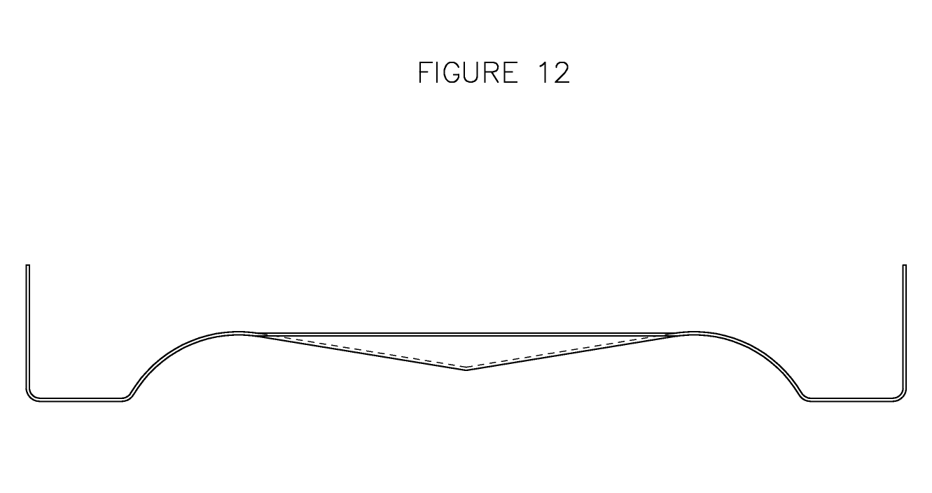

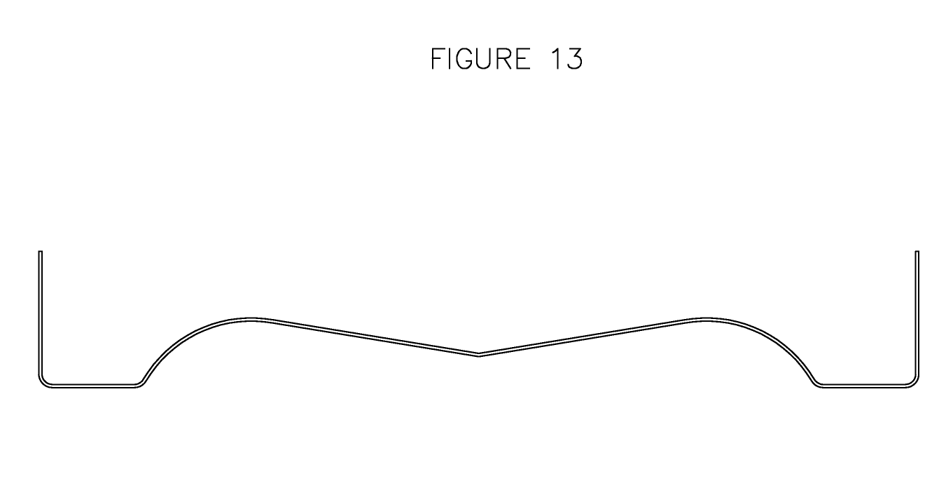

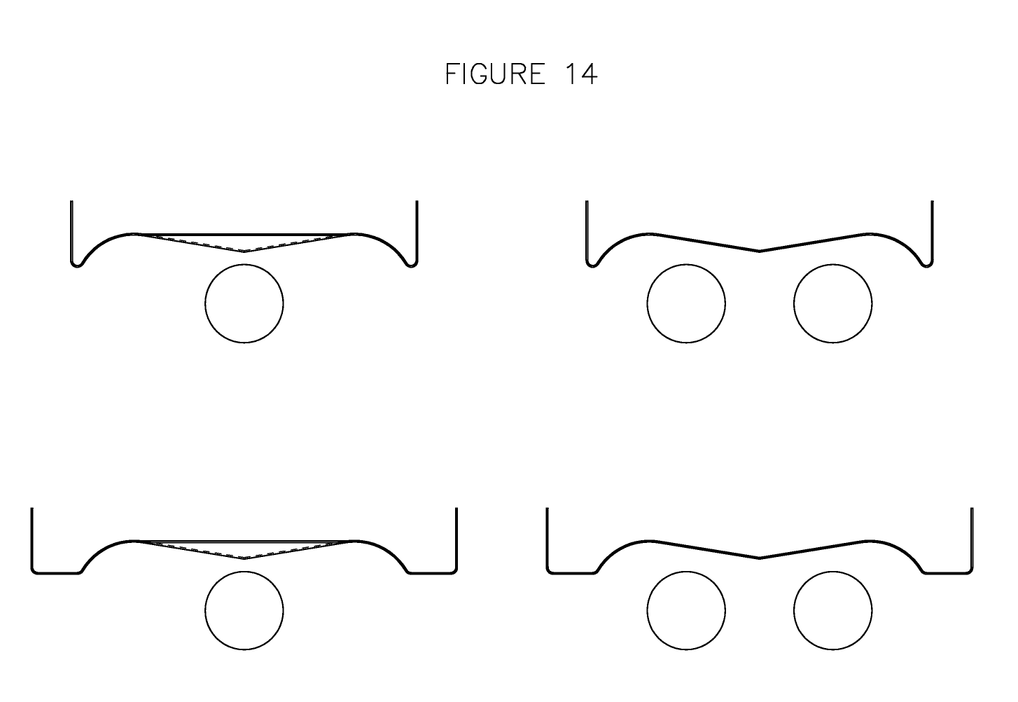

Referring to FIGS. 2-6 and 10-14, several geometries for a reflector for a fluorescent light fixture 10 are disclosed according to an exemplary embodiment. Each reflector defines a recess having a geometry that includes a reflective surface formed from a thermosetting powder coating applied on an inside surface of the reflector, as described more particularly with regard to FIGS. 7-9 herein. According to other embodiments, the thermosetting powder coating may be applied to other particular geometries, such as those shown and described in U.S. Pat. No. 6,964,502 titled “Retrofit Fluorescent Light Tube Fixture Apparatus” granted on Nov. 15, 2005, the disclosure of which is hereby incorporated by reference in its entirety. Each reflector includes an elongated member having a recess with a defined geometric shape, which may be formed by a suitable manufacturing process (e.g. stamping, etc.) and in any suitable material, such as aluminum. The reflectors may include a single recess or multiple recesses repeated in a side-by-side manner to accommodate the fluorescent light bulb patterns of a particular fluorescent light fixture. For example, FIGS. 2, 4 and 5 illustrate a “double” recess reflector and FIGS. 3 and 6 illustrate a “triple” recess reflector, however, the reflector may be formed with any desired number of recesses, and may be formed as a single unitary piece, or may be multiple recesses joined together. All such variations are intended to be within the scope of this disclosure.

Referring to FIGS. 2 and 3, a first embodiment of a reflector 120 is shown by way of example to include two recesses 122 (shown in FIG. 2) and three recesses 122 (shown in FIG. 3), each recess is configured to reflect light from a fluorescent bulb 128 having a diameter D for a two lamp light fixture (FIG. 2) and a three lamp light fixture (FIG. 3). Each recess 122 is defined by a geometric shape that includes two upper convex portions 126. Each convex portion 126 is defined by a radius R extending from a point 127 having an distance D1 above the bottom of the reflector and a lateral distance on either side of a central axis 129 of the reflector substantially equal to R. According to an exemplary embodiment, D1 is within the range of approximately 0.376-0.388 inches, and more particularly within the range of approximately 0.379-0.385 inches, and more particularly approximately 0.382 inches. According to an exemplary embodiment, R is within the range of approximately 0.380-0.392 inches, and more particularly within the range of approximately 0.383-0.389 inches, and more particularly approximately 0.386 inches. Each convex portion 126 is joined by a central concave portion 130 defined by a radius R1 within the range of approximately 0.577-0.589 inches, and more particularly within the range of approximately 0.580-0.586 inches, and more particularly approximately 0.583 inches. The fluorescent bulb 128 is spaced beneath the concave portion by a distance D3 of approximately 0.054-0.066 inches, and more particularly within a range of approximately 0.057-0.063 inches, and more particularly approximately 0.060 inches. Each convex portion 126 has an outer edge 134 that merges in a generally tangential manner with an angled wall 136. Each angled wall 136 defines an opening of the recess 122 of the reflector 126. The angled walls are sloped such that the opening has a width W1 within the range of approximately 2.240-2.252 inches, and more particularly within the range of approximately 2.243-2.249 inches, and more particularly approximately 2.246 inches. Each recess 122 is spaced from the adjacent recesses 122 so that the central axis 129 of each recess 122 is spaced at a distance D2 within the range of approximately 2.619-2.631 inches, and more particularly within the range of approximately 2.622-2.628 inches, and more particularly approximately 2.625 inches. A white reflective thermosetting powder coating 150 is applied over substantially all of the light reflecting side of each recess 126 (as described more particularly with reference to FIGS. 7-9).

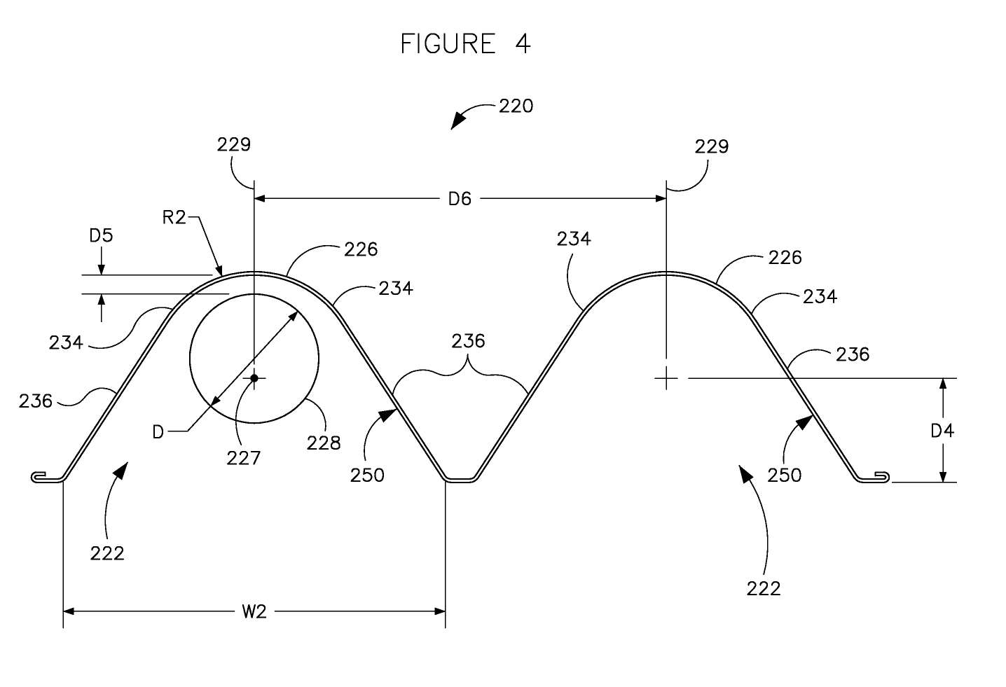

Referring to FIG. 4, a second embodiment of a reflector 220 is shown by way of example to include a two recesses 222, each recess 222 configured to reflect light from a single fluorescent bulb 228 having a diameter D for a two lamp light fixture. Each recess 222 is defined by a geometry that includes an upper convex portion 226 (i.e. one each corresponding to a separate fluorescent bulb). Each convex portion 226 is defined by a radius R2 extending from a point 227 having an distance D4 above the bottom of the reflector 220 and laterally centered on a centerline 229 of the recess. According to an exemplary embodiment, distance D4 is within the range of approximately 0.849-0.861 inches, and more particularly within the range of approximately 0.852-0.858 inches, and more particularly approximately 0.855 inches. According to one embodiment, radius R2 is within the range of approximately 0.869-0.881 inches, and more particularly within the range of approximately 0.872-0.878 inches, and more particularly approximately 0.875 inches. The fluorescent bulb 228 is spaced beneath the apex of the convex portion by a distance D5 of approximately 0.054-0.066 inches, and more particularly within a range of approximately 0.057-0.063 inches, and more particularly approximately 0.060 inches. Each convex portion 226 has an outer edge 234 that merges in a generally tangential manner with an angled wall 236. Each angled wall 236 defines an opening of the recesses 222. The angled walls are sloped such that the opening has a width W2 within the range of approximately 3.244-3.256 inches, and more particularly within the range of approximately 3.247-3.253 inches, and more particularly approximately 3.250 inches. The two recesses 222 are spaced apart from one another so that a central axis of each recess is spaced at a distance D6 within the range of approximately 3.494-3.506 inches, and more particularly within the range of approximately 3.497-3.503 inches, and more particularly approximately 3.500 inches. A white reflective thermosetting powder coating 250 is applied over substantially all of the light reflecting side of the recess 226 (as described more particularly with reference to FIGS. 7-9).

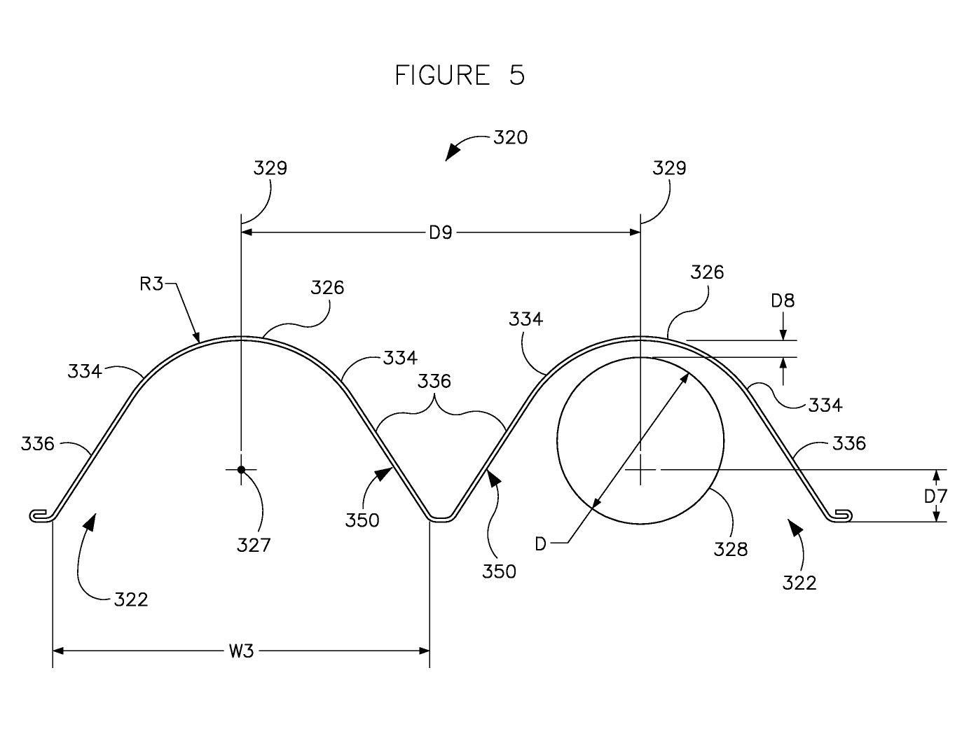

Referring to FIGS. 5 and 6, a third embodiment of a reflector 320 is shown by way of example to include two recess 322 (shown in FIG. 5) and three recesses 322 (shown in FIG. 6), each recess 322 is configured to reflect light from a corresponding parallel fluorescent bulb 328 having a diameter D for a two lamp light fixture (FIG. 5) and a three lamp light fixture (FIG. 6). Each recess is defined by a geometry that includes an upper convex portion 326 (i.e. one each corresponding to a separate fluorescent bulb). Each convex portion 326 is defined by a radius R3 extending from a point 327 having a distance D7 above the bottom of the reflector and a laterally centered on a centerline 329 of the recess. According to an exemplary embodiment, distance D7 is within the range of approximately 0.277-0.289 inches, and more particularly within the range of approximately 0.280-0.286 inches, and more particularly approximately 0.283 inches. According to an exemplary embodiment, radius R3 within the range of approximately 0.869-0.881 inches, and more particularly within the range of approximately 0.872-0.878 inches, and more particularly approximately 0.875 inches. The fluorescent bulb 328 is spaced beneath the apex of the convex portion 326 by a distance D8 of approximately 0.054-0.066 inches, and more particularly within a range of approximately 0.057-0.063 inches, and more particularly approximately 0.060 inches. Each convex portion 326 has an outer edge 334 that merges in a generally tangential manner with an angled wall 336. Each angled wall 336 defines an opening for each recess 322. The angled walls 336 are sloped such that the opening has a width W3 within the range of approximately 2.479-2.491 inches, and more particularly within the range of approximately 2.482-2.488 inches, and more particularly approximately 2.485 inches. The two recesses 322 are spaced apart from one another so that the central axis 329 of each recess 322 is spaced at a distance D9 within the range of approximately 2.619-2.631 inches, and more particularly within the range of approximately 2.622-2.628 inches, and more particularly approximately 2.625 inches. A white reflective thermosetting powder coating 350 is applied over substantially all of the light reflecting side of the recess 326 (as described more particularly with reference to FIGS. 7-9).

Referring to FIGS. 7-9, a reflective thermosetting powder coating and a method for applying the reflective thermosetting powder coating to an inner light reflecting surface of each reflector is described according to an exemplary embodiment. According to one embodiment, the reflective thermosetting powder coating is a white reflective thermosetting powder coating 150, 250, 350 having a reflectivity at 3.0 mils of at least approximately 93 (and more preferably 94, as measured by a BYK-Gardener reflectometer), such as a coating of a type commercially available from Akzo Nobel under the product name Interpon and product number JA0617. According to a preferred embodiment, the reflective thermosetting powder coating comprises a triglycidylisocyanurate (TGIC) with excellent UV resistance and optical brighteners.

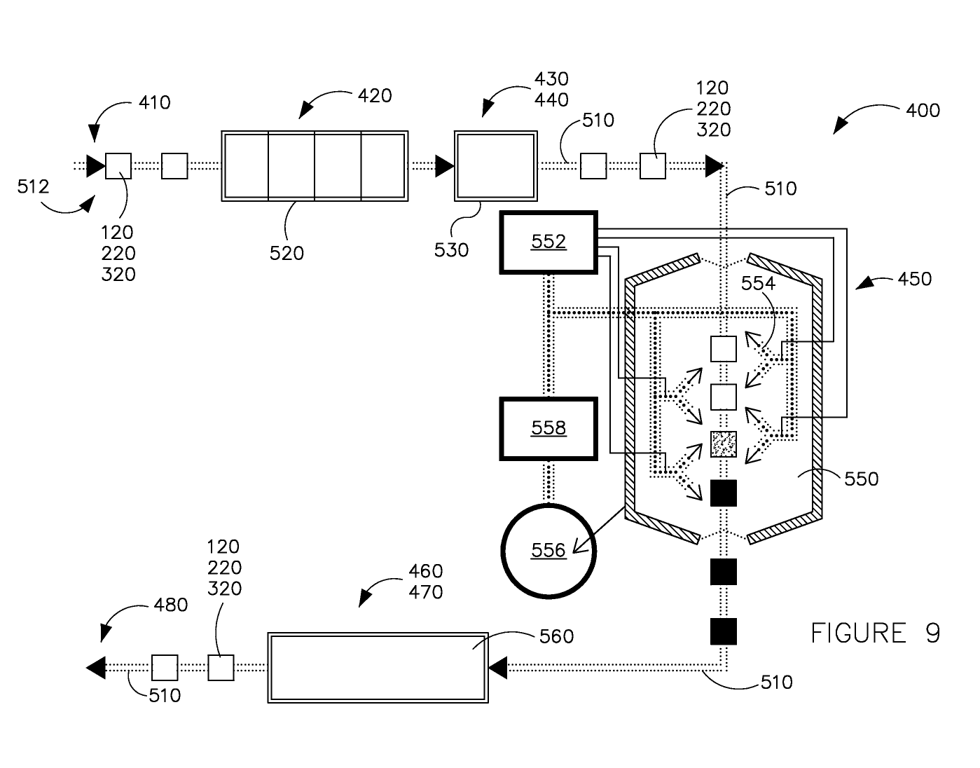

Referring to FIG. 7, the stages associated with applying the process 400 of reflective thermosetting powder coating to at least the inner surface of each recess of the reflectors for a fluorescent light fixture are shown according to an exemplary embodiment. A first stage 410 includes loading the reflectors on a suitable device for transport through the various application stages (as shown further in FIG. 9). A second stage 420 includes pre-treating the reflectors (as shown further in FIG. 8) for application of the coating. A third stage 430 includes drying the reflectors following pre-treatment, which may be accomplished by forced air and then heating (e.g. by convection oven, infrared oven, etc.) or other suitable drying process. A fourth stage 440 includes cooling the reflectors to dissipate excess heat retained by the reflectors during the drying process. A fifth stage 450 includes coating the inside surface of the reflectors with a white reflective thermosetting powder coating. A sixth stage 460 includes curing the coating that was on the reflectors. A seventh stage 470 includes cooling the coating and reflectors. An eighth stage 480 includes unloading the coated reflectors from the conveyor for transport to an assembly station where the coated reflectors are assembled with other components (e.g. frame, raceway, wiring, connectors, lampholder sockets, ballasts, bulbs, etc.) to construct a fluorescent light fixture.

Referring to FIG. 8, the pretreatment stage 420 of the process is shown according to an exemplary embodiment. The objectives of the pretreatment stage 420 are to remove impurities (e.g. soil, scale, grease, oil, etc.) from the surface of the reflector, and to condition the reflector surface for optimum adhesion of the coating, and to obtain uniformity throughout the treated surface of the reflector that will receive the coating. The first step 421 in the pretreatment stage 420 includes pre-cleaning the reflector, and involves removal of loose debris and foreign materials (if necessary). The second step 422 includes cleaning the surface of the reflector with a mildly alkaline cleaning solution (e.g. in a bath or the like) to remove any oxide layer that has formed on the surface of the reflector (e.g. for aluminum reflector embodiments), and the removal of any grease or oil and any other impurities. The third step 423 includes rinsing the reflector with clean water (e.g. reverse osmosis treated water) to remove the cleaning solution and to neutralize the cleaned surface. The applicants believe that use of reverse osmosis treated water enhances cleaning and adhesion performance. The fourth step 424 includes conditioning the surface for application of the reflective coating by applying a phosphate free conversion coating (e.g. by spray or immersion). The fifth step 425 includes another rinse of the reflector with clean water. The sixth step 426 includes a seal rinse with a dilute solution of low electrolyte concentration to provide a final passivation of the reflector surface, where any non-reacted chemicals and other contaminants are removed, and any bare spots in the conversion coating are covered.

Referring to FIG. 9, the process 400 and equipment for applying the reflective thermosetting powder 150, 250, 350 coating to the inner surface of the recess of the reflectors 120, 220, 320 for a fluorescent light fixture 10 are shown diagrammatically according to an exemplary embodiment. A conveyor system 510 is provided to transport the reflectors 120, 220, 320 through the various stages of the coating process. A loading station 512 is provided at a ‘front’ end of the conveyor 510 for manually or automatically loading the reflectors 120, 220, 320 to be coated onto the conveyor 510 for transport through the stages of the process 400. The conveyor 510 delivers the reflectors 120, 220, 320 to a pretreatment station 520 where the reflectors 120, 220, 320 are pretreated (as previously described with reference to FIG. 8). The conveyor 510 next delivers the pretreated reflectors 120, 220, 320 to a drying station 530 where the reflectors 120, 220, 320 are dried and cooled in preparation for coating with the reflective powder coating 150, 250, 350. The conveyor 151 next delivers the dried and cooled reflectors 120, 220, 320 to a powder spray and recovery booth 550, which is operated and controlled from a control console 552, for application of the reflective powder coating 150, 250, 350 to the inner surface of the reflectors 120, 220, 320. According to one embodiment, the powder spray and recovery booth 550 includes a combination of automatic and manual electrostatic spray guns 554 for applying the coating of the thermosetting powder to the surface of the reflectors 120, 220, 320. According to a particular embodiment, twelve (12) automatic and two (2) manual electrostatic spray guns 554 are used to apply the thermosetting powder onto the reflectors 120, 220, 320 to form a coating 150, 250, 350 having a thickness within a range of approximately 2.0-4.0 mils, and more particularly, 2.5-3.5 mils. Each of the guns is configured to spray only when required by the reflector geometry (i.e. length, width, etc.). A powder recovery system 556 collects any overspray material and renders it suitable for reuse and also removes powder particles from the exhaust air stream before discharge to the atmosphere. A powder supply system 558 receives reusable powder from the recovery system 556 and provides a supply of powder for use by the electrostatic spray guns 554 for application on the reflectors 120, 220, 320. Once the reflectors 120, 220, 320 are properly coated, the conveyor 510 next delivers the coated reflectors 120, 220, 320 to a curing station 560, where the coating 150, 250, 350 on the reflectors 120, 220, 320 is cured. According to one embodiment, the curing process includes oven-curing at a temperature within a range of approximately 375-425° F., and more particularly at a baseline temperature of approximately 385° F., for approximately 20 minutes. According to alternative embodiments, the curing can be accomplished using other temperatures and longer or shorter curing durations. For example, other types of coatings for other reflector applications may have a target baseline curing temperature of 350° F. for a suitable time period (e.g. approximately 20 minutes or the like). Upon completion at the curing station 560, the coated reflectors 120, 220, 320 are delivered to an unloading station 580 for removal from the conveyor 510 and transport to an assembly station (not shown) where the coated reflectors 120, 220, 320 are assembled into completed fluorescent light fixtures 10.

The Applicants have conducted an experiment in an attempt to determine the advantages of a reflector having the reflective coating applied thereon. The experiment compared the light output from a reflector having the white reflective powder coating applied thereon (“coated reflector”) and a reflector having an Alanod Miro 4 metallic reflective surface (“uncoated reflector”) mounted on the same type of fluorescent light fixture having the same type of ballast and the same type of bulb. The experiment was conducted within a temperature-controlled enclosure to determine the effects of temperature across an expected usage temperature range and to minimize influence from outside ambient lighting, and measured the illumination within the enclosure at a number of different sample point locations using a light measurement device that measured the level of illumination at each sample point within the enclosure and provided an output reading in foot-candle units. The experiment measured the average illumination in foot-candle units across: (1) the floor of the enclosure, and (2) end walls of the enclosure, and (3) the side walls of the enclosure, at a variety of ambient temperatures within the enclosure. The power input to the fixtures for both the coated reflector and the uncoated reflector were maintained substantially constant throughout the experiment.

The Applicants believe that the illumination measurement data collected during the experiment demonstrate that the light output performance of the coated reflector was greater than the uncoated reflector at certain locations and for certain temperature ranges of interest. For example, the coated reflector demonstrated greater illumination of the side wall sample points indicting a capability to provide greater light diffusion than the uncoated reflector, which tended to demonstrate greater light output on the floor (i.e. beneath the fixture). In particular, the coated reflector demonstrated greater side wall light output for typical “indoor room temperatures” (e.g. within a temperature range of about 68° F.-76° F.) than the uncoated reflector by about 10-13%. Even greater sidewall illumination capability was demonstrated at other temperatures. For example, the coated reflector demonstrated about 59% greater light output than the uncoated reflector for enclosure ambient temperature of about 35° F. These results are believed to demonstrate the ability of a coated reflector according to the present invention to provide a quantity of light output that is sufficient for most intended commercial applications, yet also provide enhanced performance in diffusing the light from the fixture (e.g. for sidewall applications, etc.), and thus perhaps reducing the quantity of fixtures necessary to provide the desired illumination within a given enclosure. The coated reflector also represents a cost reduction in comparison with the uncoated reflector, since relatively expensive reflective materials may be omitted.

According to any exemplary embodiment, a reflector having a recess with a shaped geometry is formed and then coated with a thermosetting powder coating material. The combination of the geometry(ies) of the recesses of the reflector and reflective properties of the powder coating material optimize reflection of light from a fluorescent bulb to provide increased light output in a more diffuse manner from a fixture using generally the same power input as conventional fixtures, or that can provide approximately the same light output as conventional fixtures but with reduced power input, and can be manufactured in a process that is intended to be less expensive (e.g. by avoiding the use of expensive reflector materials) than conventional fixtures. According to a preferred embodiment, the light-reflecting side of the reflectors are coated with a layer of white reflective thermosetting powder material having a thickness within the range of approximately 2.5-3.5 mils, and having a reflectivity of at least approximately 93 (as measured by a BYK-Gardner reflectometer). According to other embodiments, the coating may be other types of coating, applied to the reflector in a suitable manner, that provide a desired level of reflectivity and light diffusion characteristics desired for a particular fixture.

It is also important to note that the construction and arrangement of the elements of the reflector and coating for a fluorescent light fixture as shown schematically in the embodiments is illustrative only. Although only a few embodiments have been described in detail in this disclosure, those skilled in the art who review this disclosure will readily appreciate that many modifications are possible without materially departing from the novel teachings and advantages of the subject matter recited.

Accordingly, all such modifications are intended to be included within the scope of the present invention. Other substitutions, modifications, changes and omissions may be made in the design, operating conditions and arrangement of the preferred and other exemplary embodiments without departing from the spirit of the present invention.

Unless otherwise indicated, all numbers used in the specification and claims are to be understood as being modified in all instances by the term “about.” Accordingly, unless indicated to the contrary, the numerical parameters set forth in the following specification and attached claims are approximations that may vary depending at least upon the specific analytical technique, the applicable embodiment, or other variation according to the particular configuration of the reflector and coating.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the present invention as expressed in the appended claims.

What is claimed is:

1. A fluorescent light fixture, comprising:
a frame supporting a reflector having at least one elongated recess, the recess having a light reflecting side configured to at least partially surround at least one elongated fluorescent bulb having a diameter D, and defined by a geometry having a convex portion merging with angled sidewalls; and
a powder coating disposed on the light reflecting side of the recess of the reflector.

2. The fixture of claim 1 wherein the convex portion of the recess is defined by a radius within the range of approximately 0.869-0.881 D.

3. The fixture of claim 2 wherein the convex portion of the recess is defined by a radius within the range of approximately 0.872-0.878 D.

4. The fixture of claim 3 wherein the convex portion of the recess is defined by a radius of approximately 0.875 D.

5. The fixture of claim 1 wherein the convex portion comprises two convex portions.

6. The fixture of claim 5 wherein the two convex portions are defined by a radius within the range of approximately 0.380-0.392 D.

7. The fixture of claim 6 wherein the two convex portions are defined by a radius within the range of approximately 0.383-0.389 D.

8. The fixture of claim 7 wherein the two convex portions are defined by a radius of approximately 0.386 D.

9. The fixture of claim 1 wherein the powder coating comprises a white thermosetting powder coating.

10. The fixture of claim 9 wherein the white thermosetting powder coat has a thickness within the range of approximately 2.6-3.5 mils.

11. The fixture of claim 10 wherein the white thermosetting powder coat has a reflectivity of at least approximately 93 as measured by a BYK-Gardner reflectometer.

12. A fluorescent light fixture, comprising:
a frame supporting a reflector having at least one elongated recess, the recess having a light reflecting side configured to at least partially surround at least one elongated fluorescent bulb having a diameter D, and defined by a geometry having a convex portion merging with angled sidewalls; and
a white thermosetting powder coating disposed on the light reflecting side of the recess of the reflector, and having a thickness within the range of approximately 2-4 mils.

13. The fixture of claim 12 wherein the convex portion of the recess is defined by a radius of approximately 0.875 D.

14. The fixture of claim 12 wherein the convex portion of the recess comprises two convex portions, each convex portion defined by a radius of approximately 0.386 D.

15. The fixture of claim 12 wherein the white thermosetting powder coating comprises a triglycidylisocyanurate with UV resistance and optical brighteners and has a reflectivity of at least approximately 93 as measured by a BYK-Gardner reflectometer.

16. A method of making a fluorescent light fixture, comprising:
providing a frame supporting a reflector having at least one elongated recess, the recess having a light reflecting side configured to at least partially surround at least one elongated fluorescent bulb having a diameter D, and defined by a geometry having a convex portion merging with angled sidewalls; and
applying a white thermosetting powder coating on the light reflecting side of the recess of the reflector to a thickness within the range of approximately 2-4 mils.

17. The method of claim 16 wherein the step of applying the white thermosetting powder coating comprises spraying the coating onto the reflector using electrostatic spray guns.

18. The method of claim 16 further comprising the step of pretreating the reflector with an alkaline cleaner before the step of applying the white thermosetting powder coating.

19. The method of claim 18 further comprising the step of applying a substantially phosphate free conversion coating to the reflector before the step of applying the white thermosetting powder coating.

20. The method of claim 19 further comprising the step of curing the white thermosetting powder coating on the reflector at a temperature of at least approximately 350° F. for at least approximately 20 minutes after the step of applying the white thermosetting powder coating.
